(19) United States
(12) Patent Application Publication
(10) Pub. No.: US 2023/0179923 A1
(43) Pub. Date: Jun. 8, 2023

(54) MICRO-SPEAKER DEVICE

(71) Applicant: Vanson Electronics (Nanhai) Co., Ltd., Foshan City (CN)

(72) Inventors: Ching-Shan Hsu, Taipei City (TW); Hao-Chien Hsu, Taipei City (TW)

(73) Assignee: Vanson Electronics (Nanhai) Co., Ltd., Foshan City (CN)

(21) Appl. No.: 17/717,117

(22) Filed: Apr. 10, 2022

(30) Foreign Application Priority Data
Dec. 8, 2021 (CN) 202111492921.0

(51) Int. Cl. H04R 9/06; H04R 7/12; H04R 7/18; H04R 1/06; H04R 3/00; H04R 9/02; H04R 9/04

(52) U.S. Cl. CPC H04R 9/06; H04R 7/12; H04R 7/18; H04R 1/06; H04R 3/00; H04R 9/025; H04R 9/045; H04R 2400/11

(57) ABSTRACT

The disclosure provides a micro-speaker device including a yoke with a flat bottom plate and a sidewall perpendicular to the bottom plate, a magnet arranged on the yoke, a voice coil arranged around the magnet, a first washer arranged on the magnet, a second washer combined with the sidewall of the yoke, and a drum paper directly connected to an upper surface of the second washer. The yoke, the second washer and the drum paper define a closed space.

### BACKGROUND OF THE INVENTION

### 1. Field of the Invention

The invention relates to the technical field of loudspeaker device, in particular to a micro-speaker device with reduced volume.

### 2. Description of the Prior Art

A loudspeaker is a kind of transducer element that converts electrical signals into acoustic signals, and is an important acoustic component in electronic products. The micro-speaker module usually includes a frame and a magnetic system and a vibration system disposed within the frame. The vibration system includes a diaphragm and a voice coil arranged under the diaphragm. The voice coil drives the diaphragm to produce sound under the vibration of the magnetic system.

With the high pursuit of portability of electronic products, reduction of both of the size and weight is a necessary goal when updating various micro-speaker products. However, it is a challenge to not affect the performance of the micro-speaker when the size and weight of the micro-speaker device are reduced.

### SUMMARY OF THE INVENTION

It is one objective of the present invention to provide an improved micro-speaker device in order to solve the above-mentioned problems of the prior art.

To achieve the above objectives, the present disclosure provides the following technical solutions:

A micro-speaker device including a yoke with a flat bottom plate and a sidewall perpendicular to the bottom plate, a magnet arranged on the yoke, a voice coil arranged around the magnet, a first washer arranged on the magnet, a second washer combined with the sidewall of the yoke, and a drum paper directly connected to an upper surface of the second washer. The yoke, the second washer and the drum paper define a closed space.

According to some embodiments, the bottom plate is integrally constructed with the sidewall s.

According to some embodiments, the yoke is made of a magnetically conductive material.

According to some embodiments, the bottom plate of the yoke has a vent hole, and wherein a non-woven fabric is adhered onto the vent hole from an outer side of the bottom plate to balance air pressure during operation.

According to some embodiments, an opening is formed in a middle of the second washer, and a descending peripheral step is disposed around the opening.

According to some embodiments, the opening of the second washer is adapted to a shape of the drum paper, and the drum paper is connected to the second washer to seal the opening thereby forming the closed space, wherein the magnet, the voice coil and the first washer are accommodated in the closed space.

According to some embodiments, a descending height of the peripheral step of the second washer is about 0.3-1 mm.

According to some embodiments, the second washer is fixed to a corresponding peripheral positioning platform on the sidewalls of the yoke with glue.

According to some embodiments, the drum paper comprises a diaphragm and a surround around the diaphragm.

According to some embodiments, an upper end of the voice coil is fixedly connected with the diaphragm.

According to some embodiments, the bottom plate and the sidewalls form a rectangular parallelepiped structure with one side open, and two opposite sides in a longitudinal direction thereof have channels to allow wires for signal input to pass through.

According to some embodiments, the micro-speaker device further includes at least one circuit board for connecting leads of the voice coil and the wires.

According to some embodiments, two ends in a longitudinal direction of the second washer are provided with downwardly bent blocking pieces, and shape and size of which are adapted to the channels.

According to some embodiments, an integral lug portion is provided below the channel for clamping a rubber gasket.

According to some embodiments, the micro-speaker device further includes a buffer material connected to the second washer.

According to some embodiments, the closed space formed by the second washer, the yoke and the drum paper is an annular space surrounding the magnet.

According to some embodiments, the first washer and the peripheral step of the second washer are located on the same plane, and wherein a bottom surface of the peripheral step of the second washer is lower than a bottom surface of the first washer.

According to some embodiments, a magnetic gap is provided between the peripheral step of the first washer and the second washer, and a distance in a lateral direction between the magnet and the yoke is greater than a width of the magnetic gap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing the appearance a micro-speaker device according to an embodiment of the present invention.

FIG. 2 is an exploded view of the micro-speaker device in FIG. 1.

FIG. 3 is a schematic cross-sectional view of the micro-speaker device of the present invention.

FIG. 4 is a three-dimensional side cross-sectional view of the micro-speaker device of the present invention.

### DETAILED DESCRIPTION

In order to make the objectives, technical solutions, and advantages of the embodiments of the present invention clearer, the technical solutions in the embodiments of the present invention will be described clearly and completely in conjunction with the accompanying drawings in the embodiments of the present invention. Obviously, the described embodiments are part of the embodiments of the present invention, but not all of the embodiments. Based on the embodiments of the present invention, all other embodiments obtained by those of ordinary skill in the art without creative work shall fall within the protection scope of the present invention. Therefore, the following detailed description of the embodiments of the present invention provided in the accompanying drawings is not intended to limit the scope of the claimed invention, but merely represents selected embodiments of the present invention.

In the description of the present invention, it should be understood that the terms “center”, “longitudinal”, “transverse”, “length”, “width”, “thickness”, “upper”, “lower”, “front”, “back”, “left”, “Right”, “vertical”, “horizontal”, “top”, “bottom”, “inner”, “outer”, “clockwise”, “counterclockwise” and other directions or the positional relationship are based on the orientation or positional relationship shown in the drawings, and is only for the convenience of describing the present invention and simplifying the description, and does not indicate or imply that the pointed device or element must have a specific orientation, be constructed and operated in a specific orientation, Therefore, it shall not be interpreted as a limitation to the present invention.

In the present invention, unless otherwise clearly defined and specified, the “above” or “below” of the first feature of the second feature may include direct contact between the first and second features, or may include the first and second features not in direct contact but through other features between them. Moreover, “above”, “above” and “above” the second feature of the first feature include the first feature being directly above and obliquely above the second feature, or it simply means that the first feature is higher in level than the second feature. The “below”, “below” and “below” of the second feature of the first feature include the first feature directly below and obliquely below the second feature, or it simply means that the level of the first feature is smaller than the second feature.

The design of a speaker box of a conventional micro-speaker device typically includes: an upper cover, a lower cover, a cable for signal input, and a transducer (or drive unit) for sound-energy conversion. The transducer (or drive unit) is installed between the upper cover and the lower cover, and it is difficult to reduce the volume of the conventional speaker box. It is one object of the present disclosure to provide an improved micro-speaker module design that can reduce the size of the speaker box. By skipping some box components, the weight of the speaker box is reduced, while the same performance is kept and the coil temperature is lowered during operation.

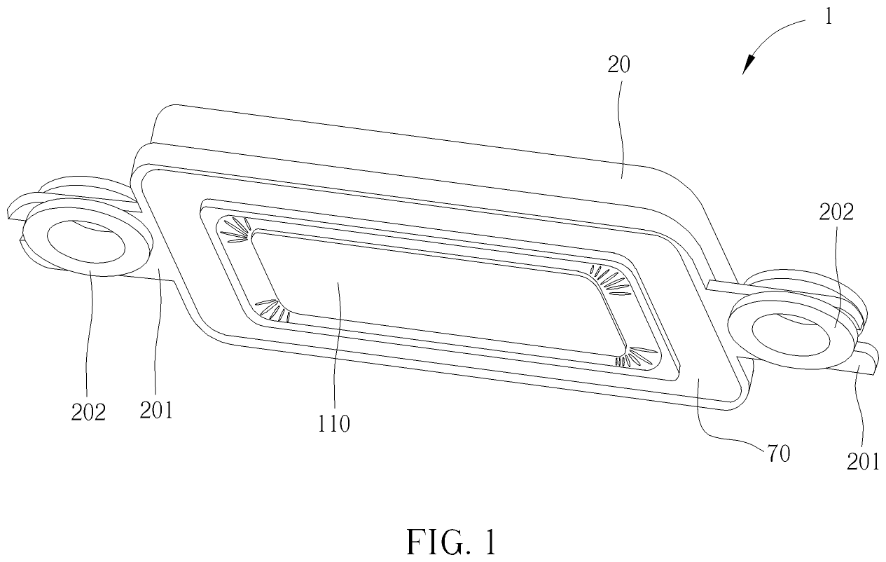

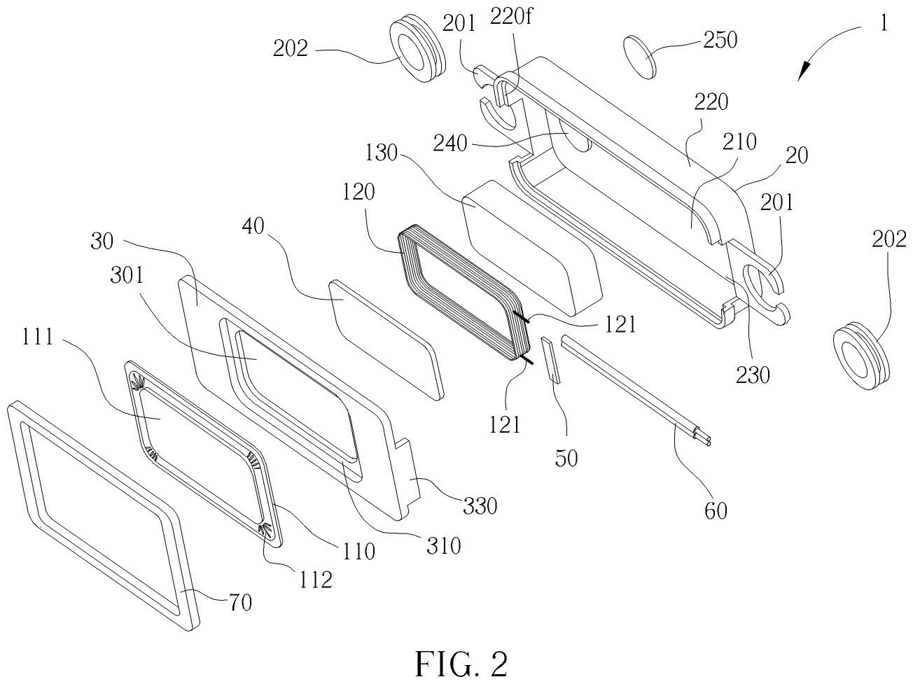

Please refer to FIG. 1 and FIG. 2. FIG. 1 is a schematic diagram showing the appearance a micro-speaker device according to an embodiment of the present invention. FIG. 2 is an exploded view of the micro-speaker device in FIG. 1. As shown in FIG. 1 and FIG. 2, the micro-speaker device 1 includes a yoke 20 having a flat bottom plate 210 and sidewalls 220 approximately perpendicular to the bottom plate 210. According to an embodiment of the present invention, the bottom plate 210 is integrally constructed with the sidewalls 220. According to an embodiment of the present invention, the yoke 20 may be made of a magnetically conductive material, such as iron, cobalt, etc., but is not limited thereto.

According to an embodiment of the present invention, the bottom plate 210 and the sidewalls 220 basically form a rectangular parallelepiped structure with its one side open, and channels 230 are provided at two opposite sidewalls in its longitudinal direction for passing the wires 60 for signal input. An integrally formed lug portion 201 may be provided below each channel 230 for clamping the rubber gasket 202. In some embodiments, the lug portion 201 and the rubber gasket 202 may be spared. According to an embodiment of the present invention, the bottom plate 210 of the yoke 20 has a vent hole 240, and a non-woven fabric 250 may be adhered onto the vent hole from the outside to balance the air pressure during operation.

According to an embodiment of the present invention, the micro-speaker device 1 further includes an elongated magnet 130 disposed on the yoke 20, a voice coil 120 disposed around the magnet 130, and a first washer 40 disposed on the magnet 130 for magnetic conduction. According to an embodiment of the present invention, the voice coil 120 is formed by windings of insulated wire and does not require a bobbin. According to an embodiment of the present invention, the voice coil 120 is arranged in a slender shape, that is, the size in the length direction is larger than the size in the width direction. According to an embodiment of the present invention, the micro-speaker device 1 further includes at least one circuit board 50 for connecting the leads 121 of the voice coil 120 and the external wires 60 for signal input. Those skilled in the art should understand that although the leads 121 in FIG. 2 extend from a single side of the voice coil 120, in some embodiments, it can also be designed as a two-terminal version, with the two leads protrude from two opposite ends in the longitudinal direction of the voice coil 120.

According to an embodiment of the present invention, the micro-speaker device 1 further includes a second washer 30 having shape and size that are similar to the bottom plate 210 of the yoke 20. The second washer 30 has an opening 301 in the middle. The size of the opening 301 is slightly larger than that of the first washer 40 and the voice coil 120. A descending peripheral step 310 is provided around the opening 301. According to an embodiment of the present invention, two ends of the second washer 30 in the longitudinal axis direction are provided with downwardly bent blocking pieces 330 having shape and size that are adapted to the channel 230. According to an embodiment of the present invention, the second washer 30 is combined with the yoke 20 so as to define an inner space of the micro-speaker device 1. According to an embodiment of the present invention, the second washer 30 can be fixed on the corresponding peripheral positioning platform 220f provided on the sidewalls 220 of the yoke 20 by using glue. According to an embodiment of the present invention, the first washer 40 and the second washer 30 may be made of magnetically conductive materials, such as iron, cobalt, etc., but not limited thereto. According to an embodiment of the present invention, the circuit board 50 may be fixed on an inner surface of the second washer 30.

According to an embodiment of the present invention, the micro-speaker device 1 further includes a drum paper 110. According to an embodiment of the present invention, the drum paper 110 may include a diaphragm 111 and a surround 112 having an arc-shaped or wavy cross-section around the diaphragm 111. According to an embodiment of the present invention, the diaphragm 111 and the surround 112 may be formed of different materials, but are not limited thereto. The upper end of the voice coil 120 is fixedly connected to the diaphragm 111. A magnetic field is provided through the magnetic structure to vibrate the voice coil 120 and drive the diaphragm 111 to vibrate and produce sound.

According to an embodiment of the present invention, the drum paper 110 is flexibly connected to the upper surface of the second washer 30. According to an embodiment of the present invention, the diaphragm 111 is arranged in an elongated shape. That is, a dimension of the diaphragm 111 in the length direction is larger than that in the width direction. According to an embodiment of the present invention, the opening 301 of the second washer 30 is adapted to the shape of the drum paper 110, and the diaphragm 111 is connected to the second washer 30 through the annular surround 112 to seal the opening 301, thereby forming a closed space. The magnet 130, the voice coil 120 and the first washer 40 are accommodated in the closed space.

According to an embodiment of the present invention, the micro-speaker device 1 further includes a buffer material 70, such as foam, sponge, silicone, rubber, etc., connected to the second washer 30 as a gasket to provide space for the diaphragm 111 to vibrate outward. According to an embodiment of the present invention, the buffer material 70 can also restrain the vibration transmitted from the micro-speaker device 1 to the external components (not shown), and prevent the diaphragm 111 from hitting other mechanisms during operation.

As mentioned above, the prior art speaker box design generally includes: an upper cover, a lower cover, a wire for signal input, and a transducer or drive unit for sound-energy conversion. The transducer or drive unit is installed between the upper cover and the lower cover. Therefore, it is difficult to reduce the volume of the traditional speaker box. In the present disclosure, the upper cover and frame of the prior art speaker box design are replaced by the second washer 30, and the lower cover is replaced by the yoke 20. Since the upper and lower covers and the frame are spared, the width, height and weight of the speaker box can be further reduced.

Another main feature of the present disclosure is that the second washer 30 is used to fix the drum paper 110. The first washer 40, the second washer 30 and the yoke 20 are made of magnetically conductive materials. A substantially sealed space is formed by the second washer 30 and the magnetic yoke 20 in the micro-speaker device 1, and the frequency response of the micro-speaker device 1 can be adjusted by controlling the sealed space.

Another advantage of the present disclosure is that the temperature of the voice coil 120 can be reduced during operation. This is because the voice coil 120 is surrounded by the yoke 20 and the second washer 30, and both the yoke 20 and the second washer 30 are made of metal with better thermal conductivity. Compared to the prior art in which the upper and lower covers are made of plastic (e.g., PC-ABS, ABS, PC, etc.), the micro-speaker device 1 of the present disclosure can achieve better thermal conductivity.

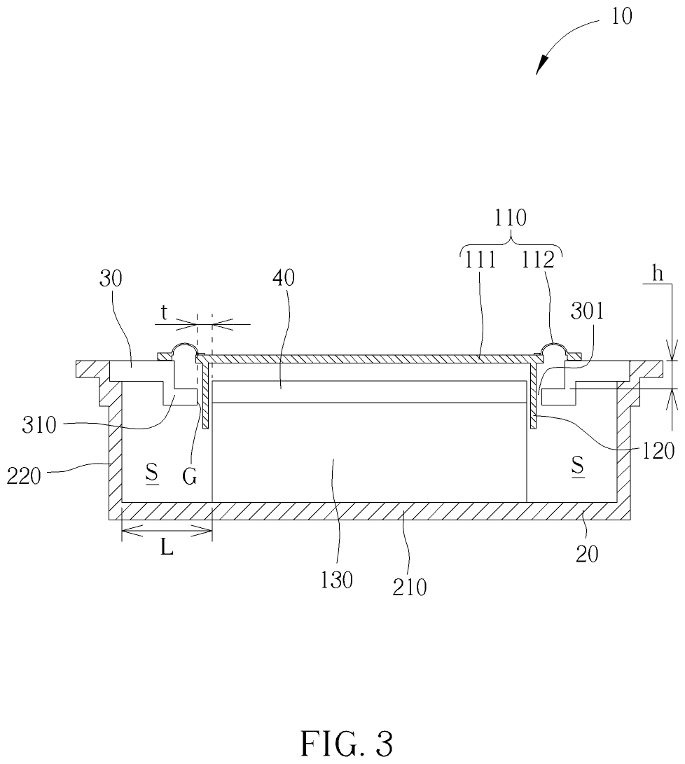

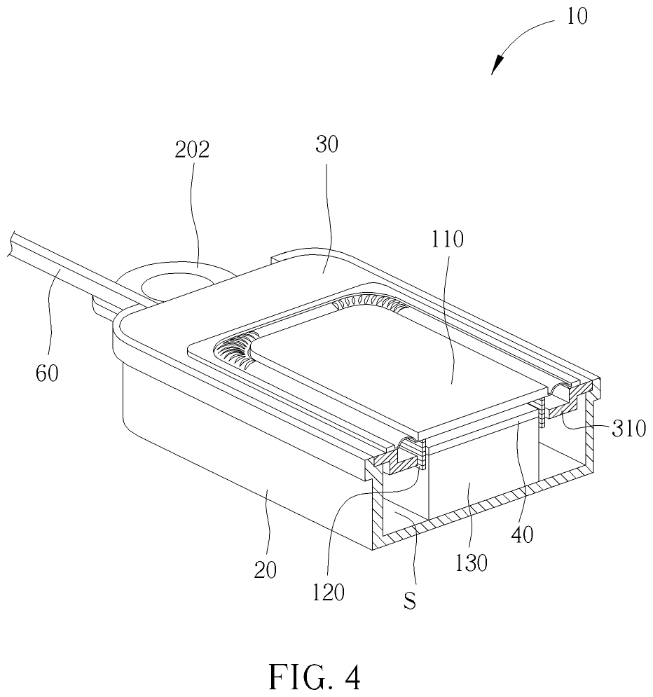

Please refer to FIG. 3 and FIG. 4. FIG. 3 is a schematic cross-sectional view of the micro-speaker device of the present invention. FIG. 4 is a three-dimensional side cross-sectional view of the micro-speaker device of the present invention, wherein like regions, layers or elements are designated by like numeral numbers or labels. As shown in FIG. 3 and FIG. 4, the surface area of the opening 301 on the second washer 30 is slightly smaller than the surface area of the drum paper 110. The second washer 30 is not a single plane structure, and a descending peripheral step 310 is arranged around the opening 301, so that the drum paper 110 can vibrate freely and will not touch the second washer 30 during operation. According to an embodiment of the present invention, the descending height h of the peripheral step 310 is about 0.3-1 mm, but is not limited thereto.

According to an embodiment of the present invention, the closed space S formed by the second washer 30, the yoke 20 and the drum paper 110 is an annular space surrounding the magnet 130. According to an embodiment of the present invention, the first washer 40 is approximately located at the opening 301 of the second washer 30. According to an embodiment of the present invention, the peripheral step 310 of the first washer 40 and the second washer 30 are approximately on the same plane, and the bottom surface of the peripheral step 310 of the second washer 30 may be slightly lower than the bottom surface of the first washer 40. According to an embodiment of the present invention, a magnetic gap G is formed between the first washer 40 and the second washer 30. In the lateral direction, the distance L between the magnet 130 and the yoke 20 is greater than the width t of the magnetic gap G.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A micro-speaker device, comprising:
a yoke having a flat bottom plate and sidewalls perpendicular to the bottom plate;
a magnet disposed on the yoke;
a voice coil disposed around the magnet;
a first washer disposed on the magnet;
a second washer coupled with the sidewalls of the yoke; and
a drum paper directly connected to an upper surface of the second washer, wherein the yoke, the second washer and the drum paper define a closed space.

2. The micro-speaker device according to claim 1, wherein the bottom plate is integrally constructed with the sidewalls.

3. The micro-speaker device of claim 1, wherein the yoke is made of a magnetically conductive material.

4. The micro-speaker device according to claim 1, wherein the bottom plate of the yoke has a vent hole, and wherein a non-woven fabric is adhered onto the vent hole from an outer side of the bottom plate to balance air pressure during operation.

5. The micro-speaker device according to claim 1, wherein an opening is formed in a middle of the second washer, and a descending peripheral step is disposed around the opening.

6. The micro-speaker device according to claim 5, wherein the opening of the second washer is adapted to a shape of the drum paper, and the drum paper is connected to the second washer to seal the opening thereby forming the closed space, wherein the magnet, the voice coil and the first washer are accommodated in the closed space.

7. The micro-speaker device of claim 5, wherein a descending height of the peripheral step of the second washer is about 0.3-1 mm.

8. The micro-speaker device of claim 1, wherein the second washer is fixed to a corresponding peripheral positioning platform on the sidewalls of the yoke with glue.

9. The micro-speaker device of claim 1, wherein the drum paper comprises a diaphragm and a surround around the diaphragm.

10. The micro-speaker device according to claim 9, wherein an upper end of the voice coil is fixedly connected with the diaphragm.

11. The micro-speaker device according to claim 1, wherein the bottom plate and the sidewalls form a rectangular parallelepiped structure with one side open, and two opposite sides in a longitudinal direction thereof have channels to allow wires for signal input to pass through.

12. The micro-speaker device according to claim 11 further comprising at least one circuit board for connecting leads of the voice coil and the wires.

13. The micro-speaker device according to claim 11, wherein two ends in a longitudinal direction of the second washer are provided with downwardly bent blocking pieces, and shape and size of which are adapted to the channels.

14. The micro-speaker device according to claim 1, wherein an integral lug portion is provided below the channel for clamping a rubber gasket.

15. The micro-speaker device according to claim 1 further comprising a buffer material connected to the second washer.

16. The micro-speaker device of claim 1, wherein the closed space formed by the second washer, the yoke and the drum paper is an annular space surrounding the magnet.

17. The micro-speaker device according to claim 5, wherein the first washer and the peripheral step of the second washer are located on the same plane, and wherein a bottom surface of the peripheral step of the second washer is lower than a bottom surface of the first washer.

18. The micro-speaker device according to claim 5, wherein a magnetic gap is provided between the peripheral step of the first washer and the second washer, and a distance in a lateral direction between the magnet and the yoke is greater than a width of the magnetic gap.
